(19) United States
(12) Patent Application Publication
(10) Pub. No.: US 2025/0063992 A1
(43) Pub. Date: Feb. 27, 2025

(54) WORKING MACHINE AND VIBRATION DAMPING MEMBER

(71) Applicant: MAKITA CORPORATION, Anjo-shi (JP)

(72) Inventor: Ryo Sunazuka, Anjo-shi (JP)

(73) Assignee: MAKITA CORPORATION, Anjo-shi (JP)

(21) Appl. No.: 18/810,048

(22) Filed: Aug. 20, 2024

(30) Foreign Application Priority Data
Aug. 25, 2023 (JP) 2023-137496

(51) Int. Cl. A01G 3/053; B26B 19/38

(52) U.S. Cl. CPC A01G 3/053; B26B 19/3866

(57) ABSTRACT

A working machine may include a first working machine part, a second working machine part, and a vibration damping member positioned between them. The vibration damping member may include a first mount portion configured to be attached to a first mount element disposed on one of the first working machine part and the second working machine part, a second mount portion offset in a first direction from the first mount portion and configured to be attached to a second mount element disposed on the other of the first working machine part and the second working machine part, a first connection portion connecting the first mount portion to the second mount portion, and a first recessed groove defined in a portion of an outer surface of the vibration damping member that corresponds to an outer surface of the first connection portion.

### REFERENCE TO RELATED APPLICATION

This application claims priority to Japanese Patent Application No. 2023-137496 filed on Aug. 25, 2023. The entire content of the priority application is incorporated herein by reference.

### TECHNICAL FIELD

Art disclosed herein relates to a working machine and a vibration damping member.

### BACKGROUND ART

Japanese Patent Application Publication No. 2014-018183 describes a working machine including a first working machine part including a working mechanism configured to be driven by a prime mover; a second working machine part including a handle configured to be grasped by a user; and a vibration damping member positioned between the first working machine part and the second working machine part. One of the first working machine part and the second working machine part includes a first mount element. The other of the first working machine part and the second working machine part includes a second mount element. The vibration damping member includes: a first mount portion configured to be attached to the first mount element; a second mount portion configured to be attached to the second mount element; and a first connection portion connecting the first mount portion to the second mount portion. When the first working machine part vibrates due to the operation of the working mechanism, the vibration damping member experiences shear deformation, which reduces vibrations from the first working machine part to the second working machine part.

### SUMMARY

The first mount portion and the second mount portion are attached to (i.e., restrained by) the first mount element and the second mount element, respectively. Thus, when the first working machine part vibrates, the first connection portion, which is not restrained by either of the first mount element or the second mount element, mainly experiences shear deformation. If the first connection portion is configured such that it does not easily undergo shear deformation, vibrations from the first working machine part may be transmitted to the second working machine part without being sufficiently reduced, as a result of which the handle may be subjected to large vibrations. Large vibrations at the handle may make the user who is grasping the handle feel uncomfortable. The disclosure herein provides a technology that allows for a reduction in user's uncomfortableness.

A working machine disclosed herein may comprise a first working machine part including a working mechanism configured to be driven by a prime mover, a second working machine part including a handle configured to be grasped by a user, and a vibration damping member positioned between the first working machine part and the second working machine part. One of the first working machine part and the second working machine part may comprise a first mount element. The other of the first working machine part and the second working machine part may comprise a second mount element. The vibration damping member may comprise a first mount portion configured to be attached to the first mount element, a second mount portion offset in a first direction from the first mount portion and configured to be attached to the second mount element, a first connection portion connecting the first mount portion to the second mount portion, and a first recessed groove defined in a portion of an outer surface of the vibration damping member that corresponds to an outer surface of the first connection portion, wherein the first recessed groove is recessed in a direction orthogonal to the first direction.

A vibration damping member disclosed herein may be positioned between a first working machine part and a second working machine part of a working machine, wherein the first working machine part includes a working mechanism configured to be driven by a prime mover and the second working machine part includes a handle configured to be grasped by a user. One of the first working machine part and the second working machine part may comprise a first mount element. The other of the first working machine part and the second working machine part may comprise a second mount element. The vibration damping member may comprise a first mount portion configured to be attached to the first mount element, a second mount portion offset in a first direction from the first mount portion and configured to be attached to the second mount element, a first connection portion connecting the first mount portion to the second mount portion, and a first recessed groove defined in a portion of an outer surface of the vibration damping member that corresponds to an outer surface of the first connection portion, wherein the first recessed groove is recessed in a direction orthogonal to the first direction.

In the configurations above, the cross-sectional area of the first connection portion along a direction orthogonal to the first direction is decreased by the first recessed groove. This means that the shear rigidity of the first connection portion is decreased in the direction orthogonal to the first direction, and thus the first connection portion is more likely to undergo shear deformation in the direction orthogonal to the first direction. By arranging the vibration damping member such that the direction in which the first working machine part vibrates is orthogonal to the first direction, the first connection portion undergoes large shear deformation when the first working machine part vibrates, thereby significantly reducing vibrations from the first working machine part to the second working machine part. Thus, the configurations above allow for a reduction in vibrations to be transmitted to the handle, and thus reduces user's uncomfortableness.

### BRIEF DESCRIPTION OF DRAWINGS

FIG. 1 shows a perspective view of a hedge trimmer 2 according to an embodiment with a rear housing 12 in a normal position, as viewed from the upper front right side.

FIG. 2 shows a right side view of an internal structure of the hedge trimmer 2 according to the embodiment.

FIG. 3 shows a perspective view of an internal structure of the rear housing 12 of the hedge trimmer 2 according to the embodiment, as viewed from the upper rear left side.

FIG. 4 shows a perspective view of the internal structure of the rear housing 12 of the hedge trimmer 2 according to the embodiment, as viewed from the upper rear left side.

FIG. 5 shows a perspective view of the hedge trimmer 2 according to the embodiment with the rear housing 12 in a rotated position, as viewed from the upper front right side.

FIG. 6 shows an exploded view of a front portion of the hedge trimmer 2 according to the embodiment.

FIG. 7 shows a perspective view of vibration damping member 90a, 90b, 90c according to an embodiment.

FIG. 8 shows a side view of the vibration damping member 90a, 90b, 90c according to the embodiment.

FIG. 9 shows a perspective view of the vibration damping member 90a, 90b, 90c according to the embodiment.

FIG. 10 shows a perspective cross-sectional view of the vibration damping member 90a, 90b, 90c according to the embodiment.

FIG. 11 shows the vibration damping member 90a according to the embodiment, a first mount element 128, a second mount element 134, and a third mount element 140.

FIG. 12 shows the vibration damping member 90a according to the embodiment attached to the first mount element 128, the second mount element 134, and the third mount element 140.

FIG. 13 shows the vibration damping member 90b according to the embodiment, a first mount element 146, a second mount element 152, and a third mount element 158.

FIG. 14 shows the vibration damping member 90c according to the embodiment, a first mount element 164, a second mount element 168, and a third mount element 174.

FIG. 15 shows the vibration damping member 90c according to the embodiment attached to the first mount element 164, the second mount element 168, and the third mount element 174.

FIG. 16A shows a cross-sectional view of the vibration damping member 90a, 90b, 90c according to the embodiment along a line A-A in FIG. 8.

FIG. 16B shows a cross-sectional view of the vibration damping member 90a, 90b, 90c according to the embodiment along a line B-B in FIG. 8.

FIG. 16C shows a cross-sectional view of the vibration damping member 90a, 90b, 90c according to the embodiment along a line C-C in FIG. 8.

FIG. 16D shows a cross-sectional view of the vibration damping member 90a, 90b, 90c according to the embodiment along a line D-D in FIG. 8.

FIG. 16E shows a cross-sectional view of the vibration damping member 90a, 90b, 90c according to the embodiment along a line E-E in FIG. 8.

FIG. 16F shows a cross-sectional view of the vibration damping member 90a, 90b, 90c according to the embodiment along a line F-F in FIG. 8.

FIG. 17 shows an exploded view of a motor housing 22 of the hedge trimmer 2 according to the embodiment.

FIG. 18 shows an enlarged cross-sectional view illustrating a cooling air passage F in the hedge trimmer 2 according to the embodiment.

FIG. 19 shows a positional relationship between an air inlet 188 of the motor housing 22 and an air outlet 196 of the rear housing 12 within a passage 192 in the hedge trimmer 2 according to the embodiment.

FIG. 20 shows the rear housing 12 according to the embodiment and a battery pack B attached to a battery receptacle 38 of the rear housing 12 as viewed in a direction of a rotation axis RA.

FIG. 21 shows a perspective view of vibration damping member 90a, 90b, 90c according to a variant.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines and vibration damping members as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

In one or more embodiments, a hollow space may be defined inside the first connection portion.

In the configuration above, the cross-sectional area of the first connection portion along the direction orthogonal to the first direction is further decreased by the hollow space. Thus, the shear rigidity of the first connection portion in the direction orthogonal to the first direction is further decreased and the first connection portion is more likely to undergo shear deformation in the direction orthogonal to the first direction. Therefore, when the first working machine part vibrates in the direction orthogonal to the first direction, vibrations from the first working machine part to the second working machine part are further reduced.

In one or more embodiments, the first mount element may comprise a first mount projection projecting in the first direction. The first mount portion may comprise a first mount hole defined in the outer surface of the vibration damping member and recessed in the first direction, wherein the first mount hole is configured to receive the first mount projection.

According to the configuration above, the first mount element is restrained by the first mount portion in the direction orthogonal to the first direction by the first mount projection being received by the first mount hole. This facilitates positioning of the first mount portion to the first mount element.

In one or more embodiments, a hollow space may be defined inside the first connection portion. The first mount hole may be connected to the hollow space.

The configuration above allows the first mount hole and the hollow space to be formed using the same mold in manufacturing the vibration damping member by mold injection. The configuration above thus facilitates manufacture of the vibration damping member.

In one or more embodiments, the second mount element may comprise a mount frame projecting in a second direction orthogonal to the first direction. The second mount portion may comprise a mount recess defined in the outer surface of the vibration damping member and recessed in the second direction, wherein the mount recess is configured to receive the mount frame.

According to the configuration above, the second mount element is restrained by the second mount portion in a direction orthogonal to the second direction by the mount frame being received by the mount recess. This facilitates positioning of the second mount portion to the second mount element.

In one or more embodiments, the second mount element may further comprise a second mount projection projecting from an outer surface of the mount frame in a third direction opposite to the first direction. The second mount portion may further comprise a second mount hole defined in a wall surface of the mount recess and recessed in the third direction, wherein the second mount hole is configured to receive the second mount projection.

In the configuration above, when the mount frame is about to detach from the mount recess, the second mount projection is caught by the second mount hole, thereby preventing the mount frame from detaching from the mount recess. The configuration above thus prevents the vibration damping member from being detached from the second mount element.

In one or more embodiments, a hollow space may be defined inside the first connection portion. The second mount hole may be connected to the hollow space.

The configuration above allows the second mount hole and the hollow space to be formed using the same mold in manufacturing the vibration damping member by mold injection. The configuration above thus facilitates the manufacture of the vibration damping member.

In one or more embodiments, the one of the first working machine part and the second working machine part may further comprise a third mount element different from the first mount element. The vibration damping member may further comprise a third mount portion offset in the first direction from the second mount portion and configured to be attached to the third mount element, a second connection portion connecting the second mount portion to the third mount portion, and a second recessed groove defined in a portion of the outer surface of the vibration damping member that corresponds to an outer surface of the second connection portion, wherein the second recessed groove is recessed in the direction orthogonal to the first direction.

According to the configuration above, the one of the first working machine part and the second working machine part further comprises an additional mount element (that is, the third mount element), and the vibration damping member is attached to the third mount element via an additional mount portion (that is, the third mount portion). This allows the vibration damping member to be attached relatively firmly to the one of the first working machine part and the second working machine part. In the configuration, however, vibrations from the first working machine part are transmitted to the second working machine part not only via the first mount element, the first mount portion, the first connection portion, the second mount portion, and the second mount element, but also via the third mount element, the third mount portion, the second connection portion, the second mount portion, and the second mount element. Therefore, if the second connection portion is configured such that it does not easily undergo shear deformation, vibrations from the first working machine part may be transmitted to the second working machine part without being sufficiently reduced. Regarding this, in the above configuration, the cross-sectional area of the second connection portion along the direction orthogonal to the first direction is decreased by the second recessed groove. This means that the shear rigidity of the second connection portion is decreased in the direction orthogonal to the first direction, and thus the second connection portion is more likely to undergo shear deformation in the direction orthogonal to the first direction. By arranging the vibration damping member such that the direction in which the first working machine part vibrates is orthogonal to the first direction, the second connection portion undergoes significant shear deformation when the first working machine part vibrates, thereby significantly reducing vibrations from the first working machine part to the second working machine part.

In one or more embodiments, the working mechanism may comprise a pair of blades configured to reciprocate relative to each other by being driven by the prime mover. The vibration damping member may be arranged such that the first direction is orthogonal to a direction in which the pair of blades reciprocates.

The above-described vibration damping member produces a remarkable vibration-damping effect against vibrations of the first working machine part in the direction orthogonal to the first direction. Thus, if the direction in which the pair of blades reciprocates is not orthogonal to the first direction, vibrations caused by the reciprocation of the pair of blades may not be sufficiently reduced and may be transmitted to the handle, which may make the user feel uncomfortable. In the configuration above, the direction in which the pair of blades reciprocates is orthogonal to the first direction, and thus vibrations caused by the reciprocation of the pair of blades are sufficiently reduced before transmitted to the handle. Therefore, the configuration above can reduce the uncomfortableness of the user grasping the handle.

### EMBODIMENT

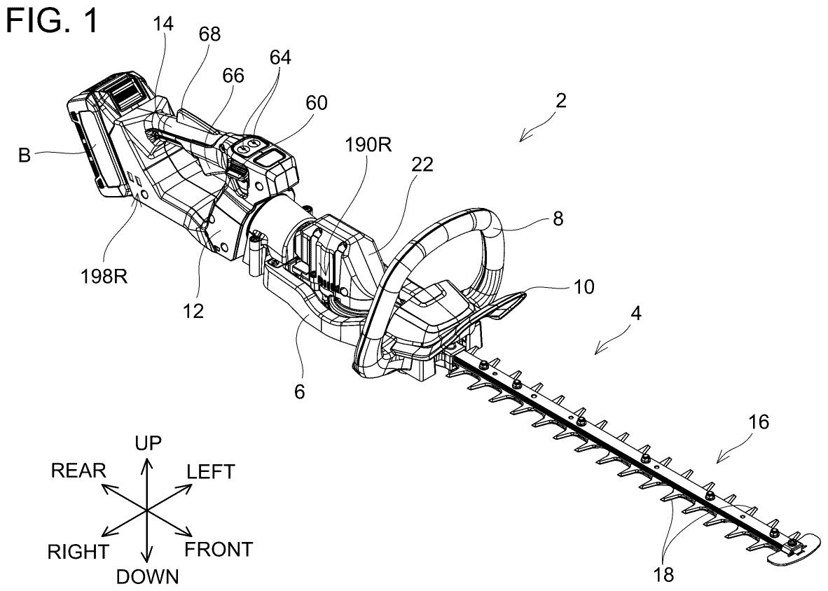

As shown in FIG. 1, a working machine according to this embodiment is a hedge trimmer 2. The hedge trimmer 2 is a gardening tool used mainly to prune hedges and plants. The hedge trimmer 2 comprises a working unit 4, a base 6 configured to support the working unit 4, a front handle 8 located on the base 6, a hand guard 10 configured to protect a hand of a user that grasps the front handle 8, a rear housing 12 attached to a rear portion of the base 6, and a rear handle 14 located on the rear housing 12.

The working unit 4 comprises a pair of shear blades 16. The pair of shear blades 16 extends linearly and comprises a plurality of cutting edges 18 along their longitudinal direction. The shear blades 16 reciprocate with each other to prune hedges and plants with the cutting edges 18. In this embodiment, regarding the longitudinal direction of the pair of shear blades 16, the direction from the base 6 toward the pair of shear blades 16 is termed a front direction and the direction from the pair of shear blades 16 toward the base 6 is termed a rear direction. Further, a direction that is orthogonal to the front-rear direction and parallel to a plane on which the cutting edges 18 of the pair of shear blades 16 lie is termed a right-left direction. Furthermore, regarding the direction orthogonal to the front-rear direction and the right-left direction, the direction from the pair of shear blades 16 toward the hand guard 10 is termed an up direction and the direction from the hand guard 10 toward the pair of shear blades 16 is termed a down direction.

The front handle 8 is located on a front portion of the base 6 and has a substantially inverted U-shape. The front handle 8 extends above and on the right and left sides of the base 6. The outer surface of the front handle 8 has a substantially cylindrical shape. The rear handle 14 is located on an upper portion of the rear housing 12 and extends linearly along the front-rear direction. The outer surface of the rear housing 12 has a substantially cylindrical shape. The user grasps the front handle 8 with one hand and the rear handle 14 with the other hand to carry the hedge trimmer 2.

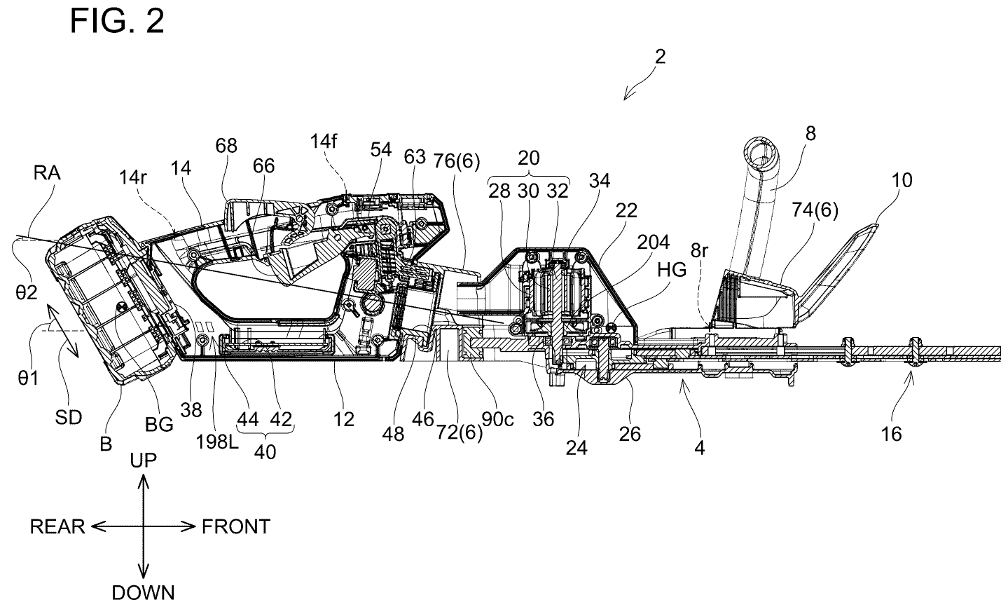

As shown in FIG. 2, the working unit 4 further comprises an electric motor 20, a motor housing 22, a power transmission mechanism 24, and a mechanism housing 26. The electric motor 20 is an inner rotor brushless motor comprising, for example, a stator 28, a rotor 30 disposed inward of the stator 28, and an output shaft 32 fixed to the rotor 30. The electric motor 20 is housed in the motor housing 22. The motor housing 22 is fixed to an upper portion of the mechanism housing 26. The output shaft 32 of the electric motor 20 is rotatably held by the motor housing 22 via a bearing 34 and also rotatably held by the mechanism housing 26 via a bearing 36. The output shaft 32 extends in the up-down direction, and a part thereof is in the motor housing 22 and another part thereof is in the mechanism housing 26. The mechanism housing 26 houses the power transmission mechanism 24 and supports the pair of shear blades 16. The output shaft 32 of the electric motor 20 is coupled to the pair of shear blades 16 via the power transmission mechanism 24. The power transmission mechanism 24 is for example a crank/cam mechanism and converts the rotation of the output shaft 32 to the reciprocation of each shear blade 16. The reciprocation direction of the shear blades 16 is along the front-rear direction.

A battery receptacle 38 to which a battery pack B is removably attached is located in a rear portion of the rear housing 12. To attach the battery pack B to the battery receptacle 38, the battery pack B is slid relative to the battery receptacle 38 in a slide direction SD from the upper rear end toward the lower front end of the battery receptacle 38. In the right side view, an inclination angle θ1 of the slide direction SD relative to the front-rear direction is for example in the range from 45 degrees to 90 degrees, and it is 60 degrees in this embodiment.

A control unit 40 configured to control units/parts of the hedge trimmer 2 is housed in a lower portion of the rear housing 12. The control unit 40 comprises a control board 42 and a controller casing 44 housing the control board 42 therein. The control board 42 includes for example a microcomputer including a CPU, a ROM, and a RAM and an inverter circuit including a plurality of switching elements (e.g., FETs). For example, the control unit 40 is configured to convert DC power from the battery pack B to three-phase AC power and supply it to the electric motor 20. The control unit 40 has a substantially flat-plate shape extending along the right-left direction. The control unit 40 is arranged such that its longitudinal direction is along the front-rear direction.

The rear housing 12 comprises a substantially cylindrical shaft portion 46. The shaft portion 46 is located in a front portion of the rear housing 12. The base 6 comprises a shaft holding portion 48 that holds the shaft portion 46 such that the shaft portion 46 is rotatable about a rotation axis RA. The shaft holding portion 48 is located in the rear portion of the base 6. The rotation axis RA lies on a plane orthogonal to the right-left direction and is inclined downward from the rear toward the front. In the right side view, an inclination angle θ2 of the rotation axis RA relative to the front-rear direction is for example in the range from 0 degrees to 30 degrees, and it is 10 degrees in this embodiment. The rotation axis RA passes the battery pack B attached to the battery receptacle 38. That is, the battery pack B attached to the battery receptacle 38 is located on the rotation axis RA.

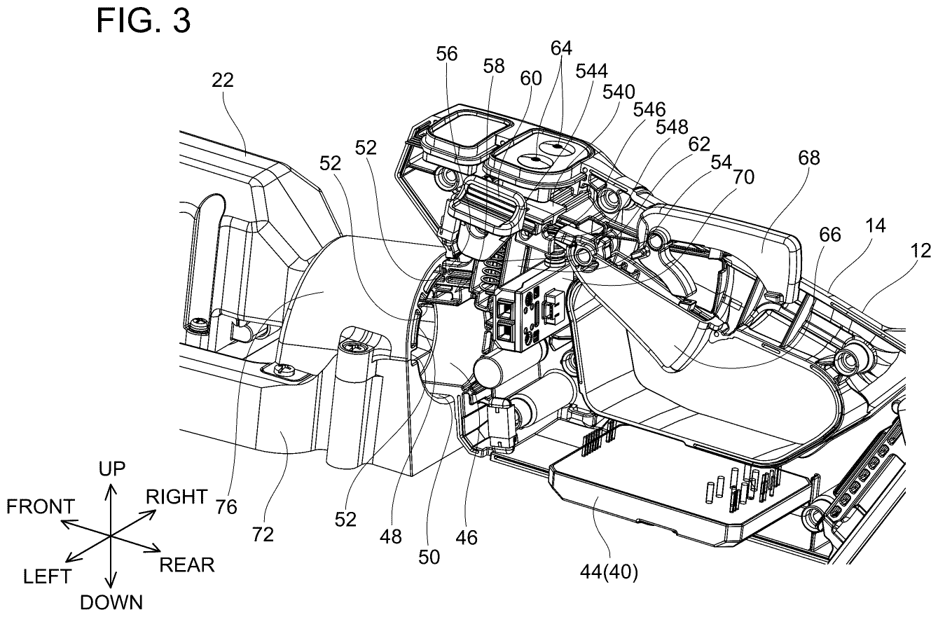

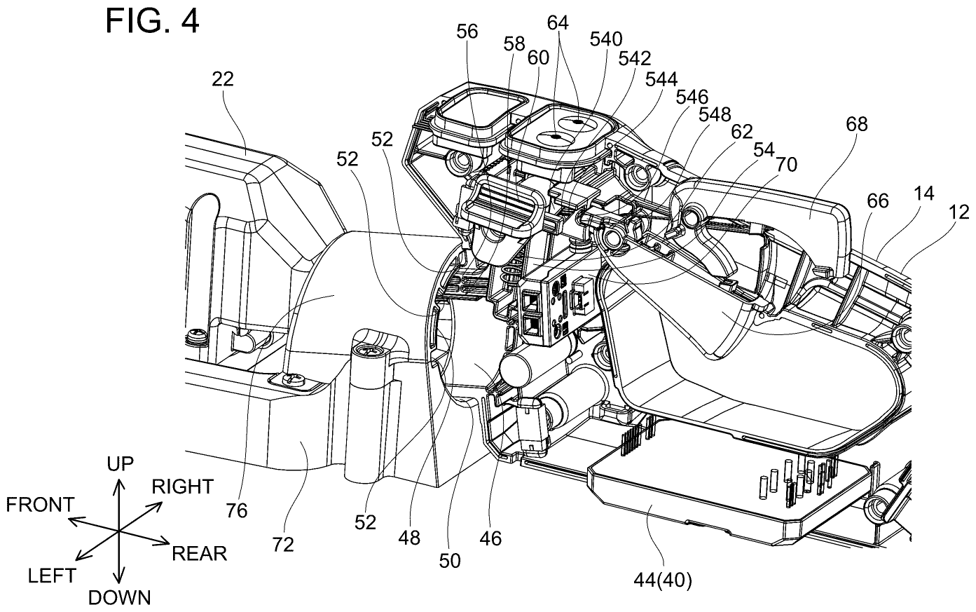

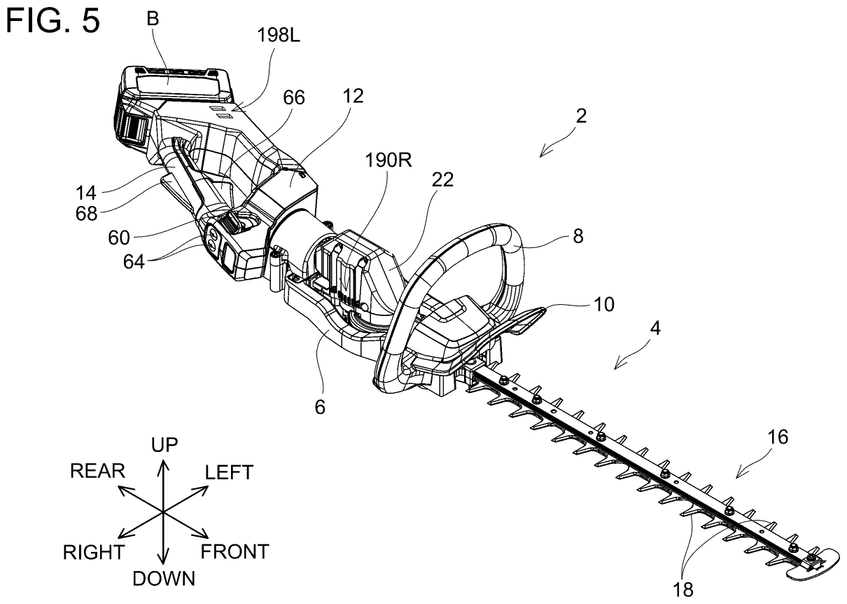

As shown in FIG. 3, the shaft holding portion 48 comprises a cylindrical surface 50 that holds the outer circumferential surface of the shaft portion 46 such that the shaft portion 46 is rotatable and a plurality of engagement grooves 52 (only partially shown) recessed from the cylindrical surface 50 in a radially outward direction of the rotation axis RA (see FIG. 2). In this embodiment, there are five engagement grooves 52. The engagement grooves 52 each extend along the rotation axis RA. In the circumferential direction of the rotation axis RA, the engagement grooves 52 are spaced from each other at predetermined intervals (e.g., at intervals at ⅛ of circumference). A rotation locking member 54 is located on the rear housing 12, and the rotation locking member 54 is configured to lock the rotation of the shaft portion 46 relative to the base 6 (i.e., the rotation of the rear housing 12 relative to the base 6). The rotation locking member 54 comprises a lock piece 56 extending along the rotation axis RA. The shaft portion 46 includes a receiving groove 58 that is recessed radially inward from the outer circumferential surface of the shaft portion 46 and configured to receive the lock piece 56. The receiving groove 58 extends along the rotation axis RA. When the receiving groove 58 and one of the engagement grooves 52 face each other in the radial direction of the rotation axis RA, the rotation locking member 54 is slidable between a lock position where the lock piece 56 is received by the engagement groove 52 as shown in FIG. 3 and an unlock position where the lock piece 56 is received by the receiving groove 58 as shown in FIG. 4. A manipulation member 60 is fixed to the rotation locking member 54. As shown in FIGS. 1 and 5, the manipulation member 60 is exposed to right and left outer surfaces of the rear housing 12 and is slidable along the outer surface of the rear housing 12. The user can slide the rotation locking member 54 by manipulating the manipulation member 60. As shown in FIGS. 3 and 4, a coil spring 62 is attached to the rotation locking member 54. The lower end of the coil spring 62 contacts a support projection 63 (see FIG. 2) formed on the inner wall of the rear housing 12. The coil spring 62 biases the rotation locking member 54 upward relative to the support projection 63. Thus, when the manipulation member 60 is not manipulated by the user, the rotation locking member 54 is retained in the lock position shown in FIG. 3 by the biasing force of the coil spring 62. When the rotation locking member 54 is in the lock position, the rear housing 12 is mechanically locked to the base 6 and the rear housing 12 is thereby prohibited from rotating relative to the base 6. When the user pushes down the manipulation member 60 against the biasing force of the coil spring 62, the rotation locking member 54 moves to the unlock position shown in FIG. 4. When the rotation locking member 54 is in the unlock position, the rear housing 12 is not locked to the base 6 and the rear housing 12 is thus permitted to rotate relative to the base 6.

The user can change the position of the rear housing 12 relative to the base 6 by rotating the rear housing 12 to engage the lock piece 56 with another engagement groove 52 after the rotation locking member 54 has moved to the unlock position. Thereby, the position of the rear housing 12 can be changed from the normal position shown in FIG. 1 to for example a rotated position shown in FIG. 5. In the following description, the rear housing 12 is in the normal position shown in FIG. 1 unless otherwise stated.

As shown in FIG. 3, a manipulation button 64, a trigger lever 66, and a lock-off lever 68 are located on the rear housing 12. The manipulation button 64 is located on the upper surface of the rear handle 14. By manipulating the manipulation button 64, the user can switch on/off of the main power of the hedge trimmer 2, change the rotation speed of the electric motor 20, cause the electric motor 20 to rotate in the reverse direction, etc. The trigger lever 66 is located on a lower portion of the rear handle 14 such that the user can manipulate it with the index finger of the hand grasping the rear handle 14. The lock-off lever 68 is located on an upper portion of the rear handle 14 such that the user can manipulate it with the palm of the hand grasping the rear handle 14. The trigger lever 66 is usually mechanically locked by the lock-off lever 68. When the lock-off lever 68 is pushed, the trigger lever 66 is unlocked and thereby permitted to be pulled up. When the trigger lever 66 is pulled up, a microswitch 70 housed in the rear housing 12 is thereby pressed. When the microswitch 70 is pressed while the main power of the hedge trimmer 2 is on, the control unit 40 actuates the electric motor 20 to drive the pair of shear blades 16. When the trigger lever 66 is released, the pressing on the microswitch 70 is released. In response to this, the control unit 40 stops the electric motor 20 to stop the pair of shear blades 16. As above, the user can actuate the pair of shear blades 16 by pushing the lock-off lever 68 and pulling up the trigger lever 66 while the main power of the hedge trimmer 2 is on.

A slider 540 is coupled to the rotation locking member 54, and the slider 540 is held by the rear housing 12 such that the slider 540 is slidable along the front-rear direction. The slider 540 is coupled to the rotation locking member 54 by inserting a pin 542 of the rotation locking member 54 into an elongated hole 544 of the slider 540. As the rotation locking member 54 slides, the pin 542 moves along the elongated hole 544 and thus the slider 540 slides. The slider 540 includes a notch 546 in a rear portion of the slider 540. The trigger lever 66 includes a projection 548 configured to be insertable to the notch 546. When the rotation locking member 54 is in the lock position as shown in FIG. 3, the slider 540 does not mechanically interfere with the trigger lever 66. When the rotation locking member 54 moves to the unlock position as shown in FIG. 4, the slider 540 moves rearward and the projection 548 of the trigger lever 66 is inserted into the notch 546. The trigger lever 66 is thereby mechanically locked. Thus, when the user changes the position of the rear housing 12 relative to the base 6, the trigger lever 66 cannot be manipulated and the pair of shear blades 16 is thus prohibited from being driven.

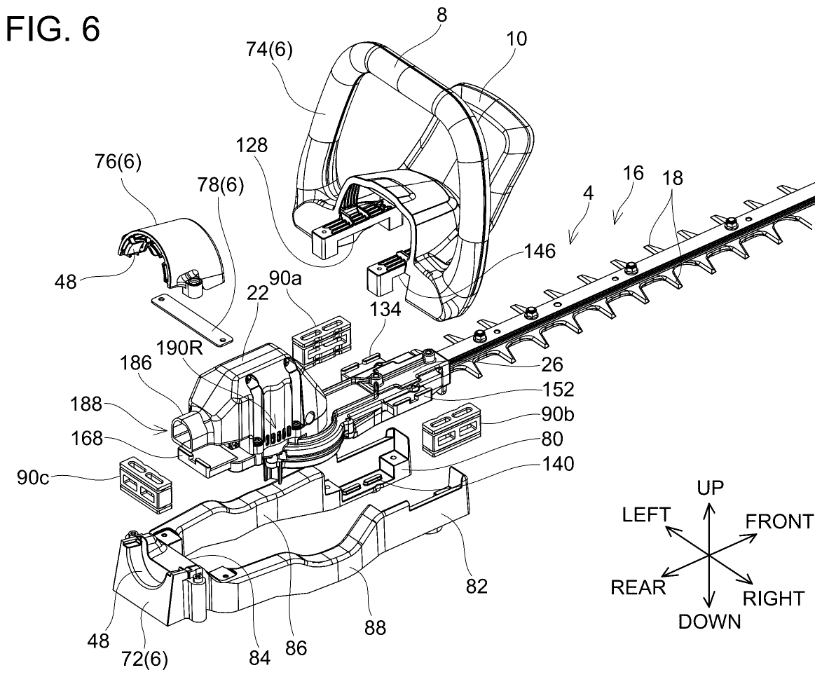

As shown in FIG. 6, the base 6 comprises a base body 72, a handle member 74, a semicylindrical member 76, and a plate member 78. The base body 72, the handle member 74, the semicylindrical member 76, and the plate member 78 are fixed to each other with screws (not shown). The handle member 74 forms the front handle 8 and the hand guard 10. The base 6 comprises a left support 80 supporting a left portion of the mechanism housing 26 via a vibration damping member 90a, a right support 82 supporting a right portion of the mechanism housing 26 via a vibration damping member 90b, a rear support 84 supporting a rear portion of the mechanism housing 26 via a vibration damping member 90c, a left arm 86 extending on the left side of the mechanism housing 26 and connecting the left support 80 to the rear support 84, and a right arm 88 extending on the right side of the mechanism housing 26 and connecting the right support 82 to the rear support 84.

### Vibration Damping Members 90a, 90b, 90c

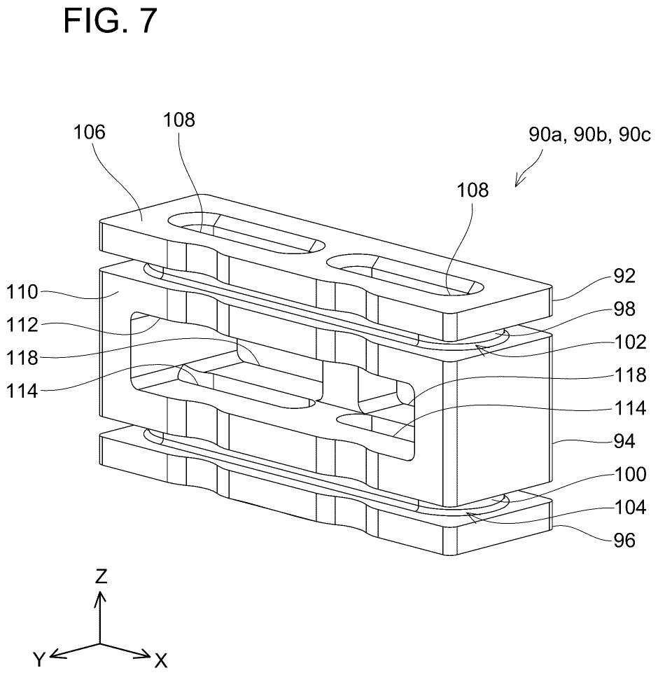

As shown in FIG. 7, the vibration damping members 90a, 90b, 90c each have a substantially cuboid shape. The vibration damping members 90a, 90b, 90c are constituted of a rubber material (i.e., silicon rubber). The vibration damping members 90a, 90b, 90c are manufactured for example by injection molding. In this embodiment, a length direction, a width direction, and a height direction of the vibration damping members 90a, 90b, 90c are defined as X direction, Y direction, and Z direction, respectively. The dimension of each vibration damping member 90a, 90b, 90c in X direction is for example in the range from 20 mm to 70 mm, and it is 50 mm in this embodiment. The dimension of each vibration damping member 90a, 90b, 90c in Y direction is for example in the range from 10 mm to 30 mm, and it is 15 mm in this embodiment. The dimension of each vibration damping member 90a, 90b, 90c in Z direction is for example in the range from 10 mm to 40 mm, and it is 25 mm in this embodiment. Each of the vibration damping members 90a, 90b, 90c is symmetric with respect to X and Z directions. Therefore, the following description of the vibration damping members 90a, 90b, 90c holds true even when +X direction and −X direction are interchanged and/or +Z direction and −Z direction are interchanged.

The vibration damping members 90a, 90b, 90c comprise common elements. Therefore, hereinafter, the elements of the vibration damping members 90a, 90b, 90c are labeled with same reference signs. It should be noted that only the configuration of the vibration damping member 90a is described hereinafter but the vibration damping members 90b, 90c have the same configuration unless otherwise stated.

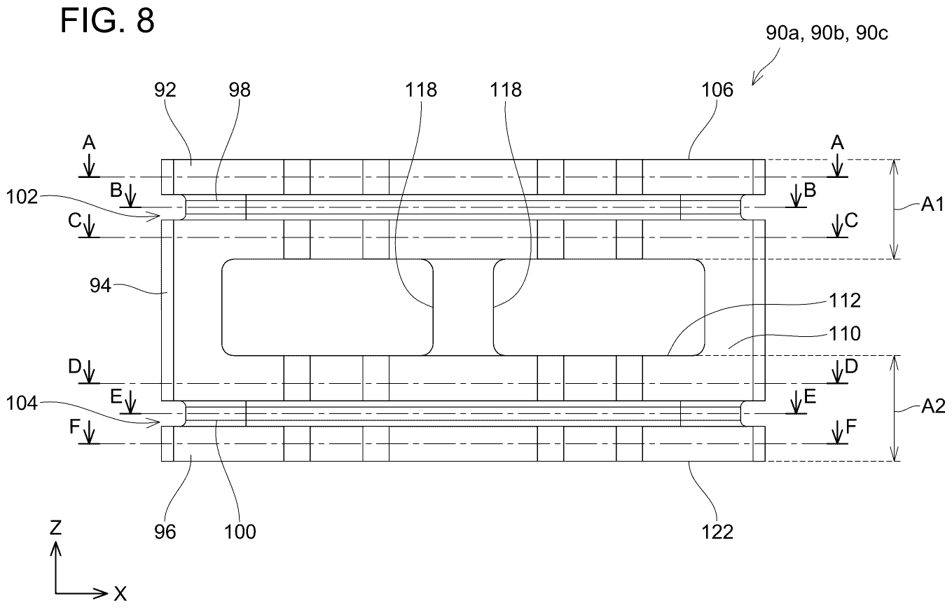

As shown in FIG. 8, the vibration damping member 90a comprises a first mount portion 92, a second mount portion 94 offset from the first mount portion 92 in −Z direction, a third mount portion 96 offset from the second mount portion 94 in −Z direction, a first connection portion 98 connecting the first mount portion 92 to the second mount portion 94, and a second connection portion 100 connecting the second mount portion 94 to the third mount portion 96. A first recessed groove 102 is defined in a portion of the outer surface of the vibration damping member 90a that corresponds to the outer surface of the first connection portion 98. A second recessed groove 104 is defined in a portion of the outer surface of the vibration damping member 90a that corresponds to the outer surface of the second connection portion 100. The first recessed groove 102 and the second recessed groove 104 both extend along the full periphery of the vibration damping member 90a with respect to an X-Y plane.

As shown in FIG. 7, the first mount portion 92 has a plate shape expanding along the X-Y plane. The first mount portion 92 comprises a mount surface 106 oriented in +Z direction and a plurality of mount holes 108 recessed in −Z direction from the mount surface 106. The mount holes 108 are elongated holes each having a longitudinal direction along X direction.

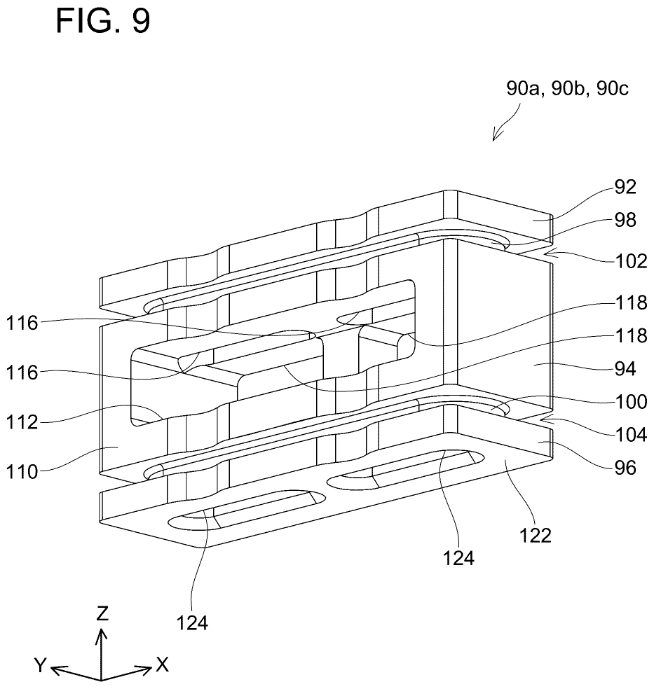

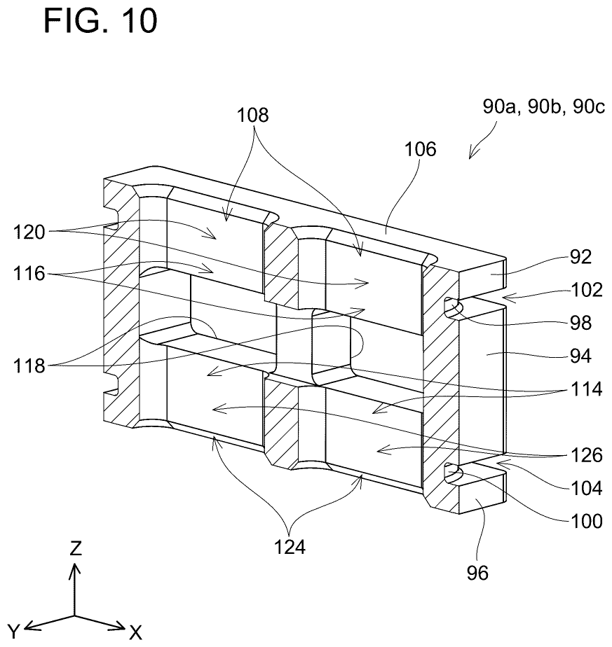

The second mount portion 94 has a substantially cuboid shape having the length direction along X direction, the width direction along Y direction, and the height direction along Z direction. The second mount portion 94 comprises an end surface 110 oriented in +Y direction, a mount recess 112 recessed in −Y direction from the end surface 110, a plurality of mount holes 114 recessed in −Z direction from a wall surface of the mount recess 112, a plurality of mount holes 116 recessed in +Z direction from a wall surface of the mount recess 112 (see FIG. 9), and a plurality of lightening holes 118 penetrating the bottom surface of the mount recess 112 in −Y direction. As shown in FIG. 10, each mount hole 116 is connected to a corresponding mount hole 108 in the first mount portion 92 via a hollow space 120 defined in the first connection portion 98. In this embodiment, wall surfaces defining the mount holes 116, wall surfaces defining the hollow spaces 120, and wall surfaces defining the mount holes 108 are smoothly connected to each other.

As shown in FIG. 9, as with the first mount portion 92, the third mount portion 96 has a plate shape expanding along the X-Y plane. The third mount portion 96 comprises a mount surface 122 oriented in −Z direction and a plurality of mount holes 124 recessed in +Z direction from the mount surface 122. The mount holes 124 are elongated holes each having a longitudinal direction along X direction. As shown in FIG. 10, each mount hole 124 is connected to a corresponding mount hole 114 in the second mount portion 94 via a hollow space 126 defined in the second connection portion 100. In this embodiment, wall surfaces defining the mount holes 124, wall surfaces defining the hollow spaces 126, and wall surfaces defining the mount holes 114 are smoothly connected to each other.

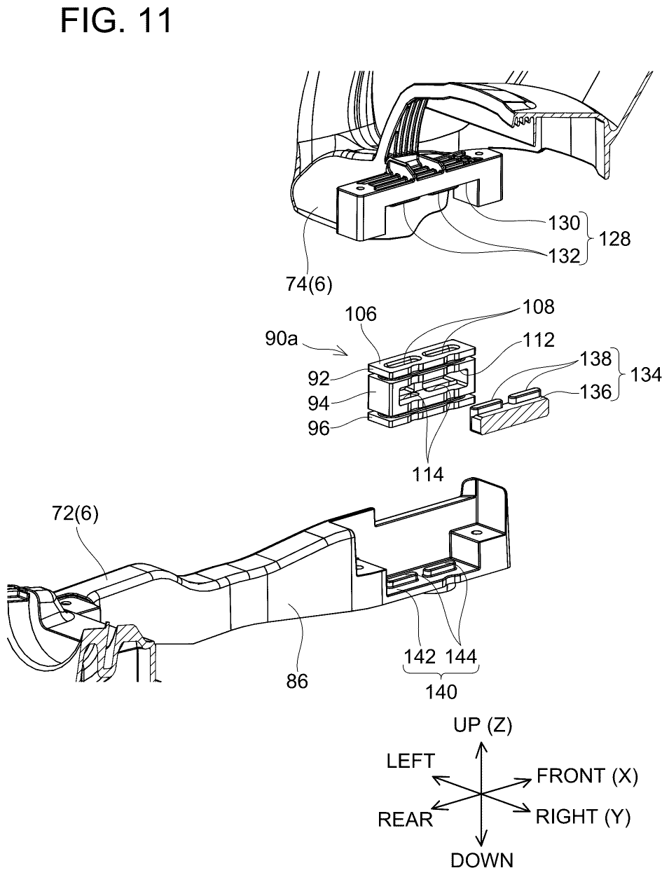

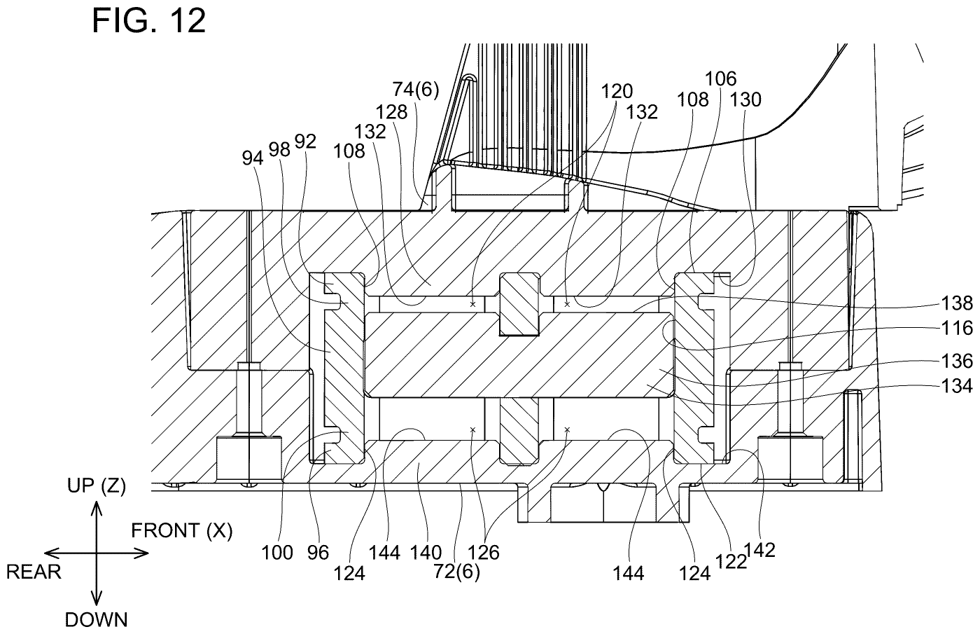

As shown in FIG. 11, the vibration damping member 90a is arranged such that +X direction coincides with the front direction, +Y direction coincides with the right direction, and +Z direction coincides with the up direction. The first mount portion 92 is attached to a first mount element 128 located in a left portion of the handle member 74. The first mount element 128 comprises a support surface 130 oriented downward (in −Z direction) and a plurality of mount projections 132 projecting downward (in −Z direction) from the support surface 130. The mount projections 132 each have a shape configured to fit in the mount holes 108. As shown in FIG. 12, the first mount portion 92 is mounted to the first mount element 128 by fitting the mount projections 132 into the mount holes 108 and bringing the mount surface 106 into contact with the support surface 130. The second mount portion 94 shown in FIG. 11 is mounted to a second mount element 134 located on a left portion of the mechanism housing 26 (see FIG. 6). The second mount element 134 comprises a mount frame 136 projecting leftward (in −Y direction) from the outer surface of the mechanism housing 26 and a plurality of mount projections 138 projecting upward (in +Z direction) from the upper surface of the mount frame 136. The mount frame 136 has a shape configured to fit in the mount recess 112. The mount projections 138 each have a shape configured to fit in the mount holes 116 (see FIG. 9). As shown in FIG. 12, the second mount portion 94 is mounted to the second mount element 134 by fitting the mount frame 136 into the mount recess 112 and fitting the mount projections 138 into the mount holes 116. The third mount portion 96 shown in FIG. 11 is mounted to a third mount element 140 located in the left arm 86. The third mount element 140 comprises a support surface 142 oriented upward (in +Z direction) and a plurality of mount projections 144 projecting upward (in +Z direction) from the support surface 142. The mount projections 144 each have a shape configured to fit in the mount holes 124 (see FIG. 9). As shown in FIG. 12, the third mount portion 96 is mounted to the third mount element 140 by fitting the mount projections 144 into the mount holes 124 and bringing the mount surface 122 into contact with the support surface 142. The vibration damping member 90a is typically held between the base body 72 and the handle member 74 and compressed in the up-down direction (Z direction).

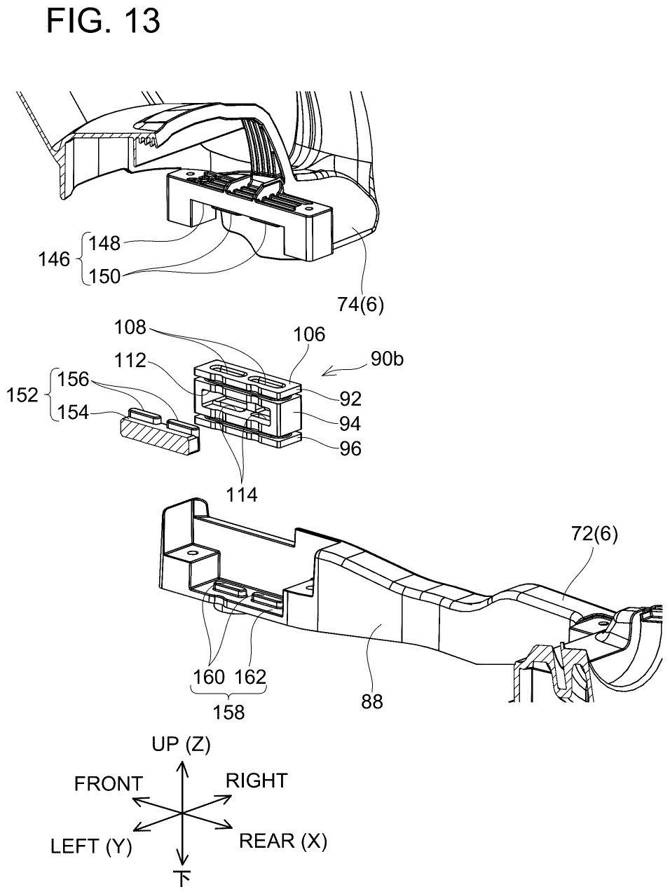

As shown in FIG. 13, the vibration damping member 90b is arranged such that +X direction coincides with the rear direction, +Y direction coincides with the left direction, and +Z direction coincides with the up direction. The first mount portion 92 is mounted to a first mount element 146 located in a right portion of the handle member 74. The first mount element 146 comprises a support surface 148 and a plurality of mount projections 150. The second mount portion 94 is mounted to a second mount element 152 located on a right portion of the mechanism housing 26 (see FIG. 6). The second mount element 152 comprises a mount frame 154 and a plurality of mount projections 156. The third mount portion 96 is mounted to a third mount element 158 located in the right arm 88. The third mount element 158 comprises a support surface 160 and a plurality of mount projections 162. The first mount element 146, the second mount element 152, and the third mount element 158 have substantially the same shapes as those of the above-described first mount element 128, second mount element 134, and third mount element 140, respectively, and thus detailed descriptions for the first mount element 146, the second mount element 152, and the third mount element 158 are omitted. The vibration damping member 90b is typically held between the base body 72 and the handle member 74 and compressed in the up-down direction (Z direction).

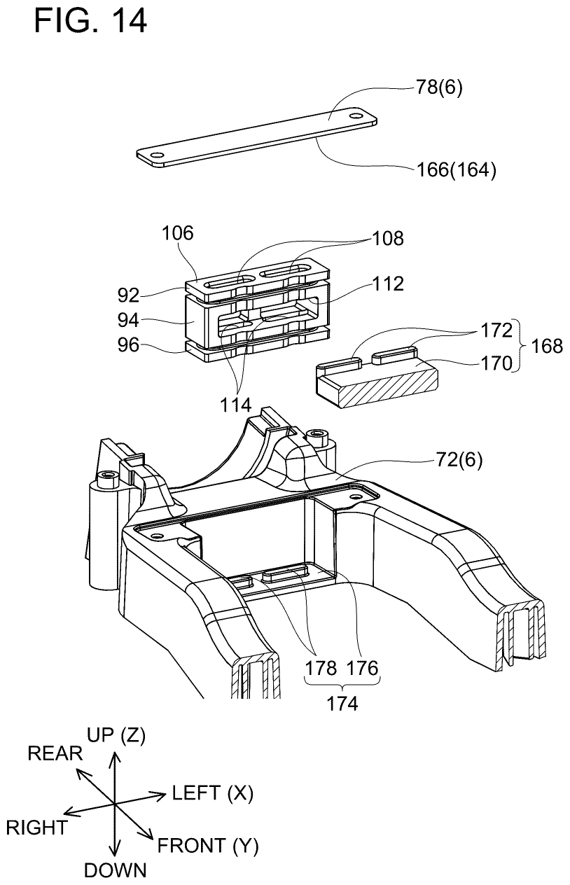

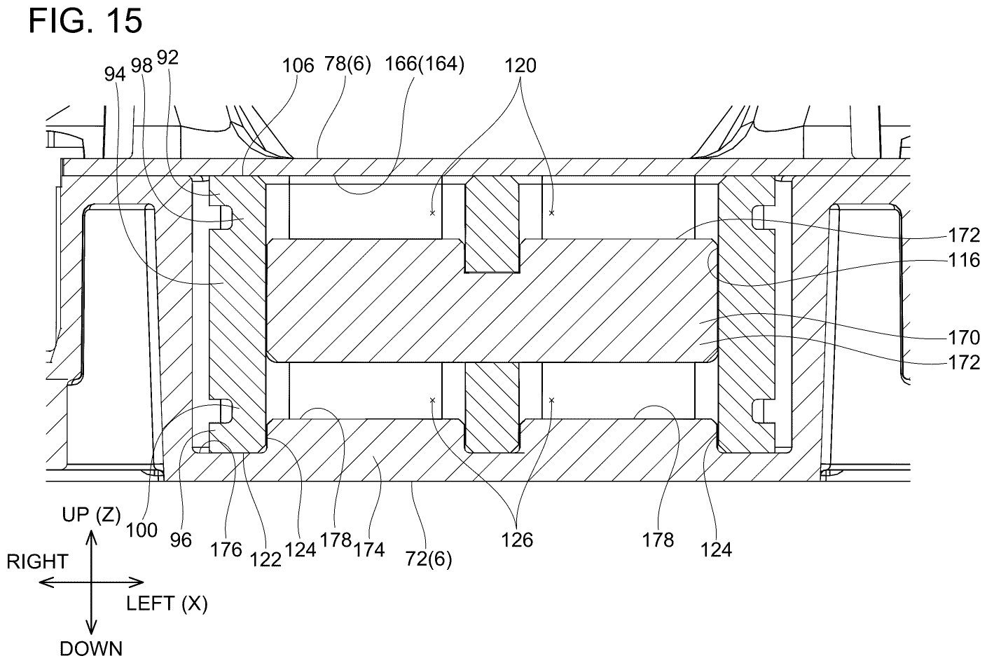

As shown in FIG. 14, the vibration damping member 90c is arranged such that +X direction coincides with the left direction, +Y direction coincides with the front direction, and +Z direction coincides with the up direction. The first mount portion 92 is mounted to a first mount element 164 located on the plate member 78. The first mount element 164 comprises a support surface 166 (i.e., the lower surface of the plate member 78). Unlike the above-described first mount elements 128 and 146, the first mount element 164 does not comprise any projections configured to fit in the mount holes 108 in the first mount portion 92. As shown in FIG. 15, the first mount portion 92 is mounted to the first mount element 164 by bringing the mount surface 106 into contact with the support surface 166. The second mount portion 94 is mounted to a second mount element 168 located on a rear portion of the mechanism housing 26 (see FIG. 6). The second mount element 168 comprises a mount frame 170 and a plurality of mount projections 172. The third mount portion 96 is mounted to a third mount element 174 located in a rear portion of the base body 72. The third mount element 174 comprises a support surface 176 and a plurality of mount projections 178. The second mount element 168 and the third mount element 174 have substantially the same shapes as those of the above-described second mount elements 134, 152 and third mount elements 140, 158, respectively, and thus detailed descriptions for the second mount element 168 and the third mount element 174 are omitted. The vibration damping member 90c is typically held between the base body 72 and the plate member 78 and compressed in the up-down direction (Z direction).

As shown in FIG. 8, a first vibration damping region A1 is a region between the mount surface 106 and a +Z direction wall surface of the mount recess 112 in each of the vibration damping members 90a, 90b, 90c. Vibrations from the first mount elements 128, 146, 164 (see FIG. 6) are transmitted to the second mount elements 134, 152, 168 (see FIG. 6) or vice versa mainly via the first vibration damping regions A1. A second vibration damping region A2 is a region between the mount surface 122 and a −Z direction wall surface of the mount recess 112 in each of the vibration damping members 90a, 90b, 90c. Vibrations from the second mount elements 134, 152, 168 are transmitted to the third mount elements 140, 158, 174 (see FIG. 6) or vice versa mainly via the second vibration damping regions A2.

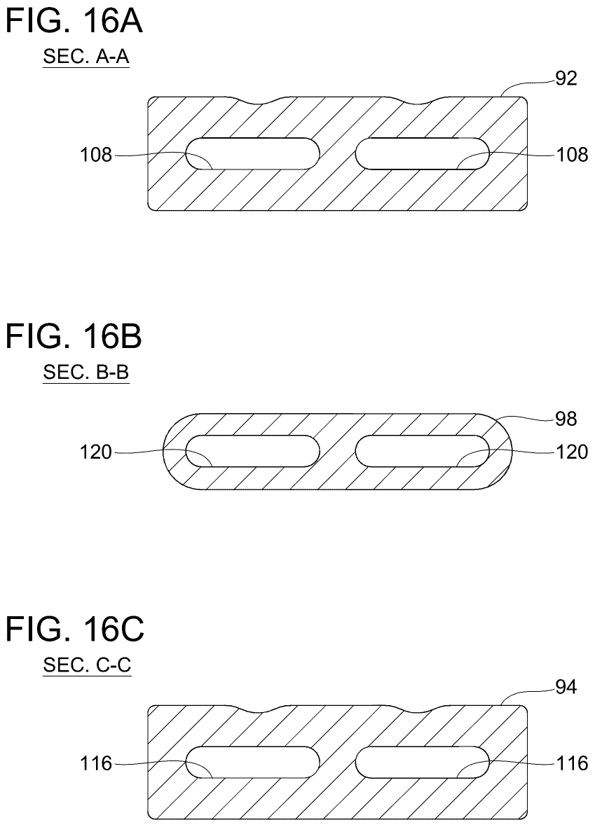

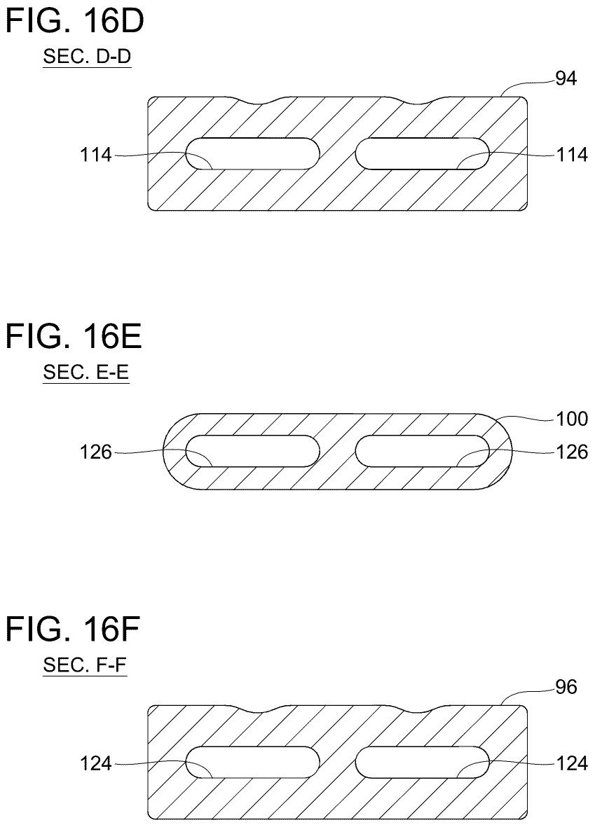

A cross section A-A shown in FIG. 16A is a cross section of a part of the first vibration damping region A1 that corresponds to the first mount portion 92, along a direction orthogonal to Z direction. A cross section B-B shown in FIG. 16B is a cross section of a part of the first vibration damping region A1 that corresponds to the first connection portion 98, along the direction orthogonal to Z direction. A cross-section C-C shown in FIG. 16C is a cross section of a part of the first vibration damping region A1 that corresponds to the second mount portion 94, along the direction orthogonal to Z direction. A cross section D-D shown in FIG. 16D is a cross section of a part of the second vibration damping region A2 that corresponds to the second mount portion 94, along the direction orthogonal to Z direction. A cross-section E-E shown in FIG. 16E is a cross section of a part of the second vibration damping region A2 that corresponds to the second connection portion 100, along the direction orthogonal to Z direction. A cross section F-F shown in FIG. 16F is a cross section of a part of the second vibration damping region A2 that corresponds to the third mount portion 96, along the direction orthogonal to Z direction. In this embodiment, a magnitude relationship Sa=Sc=Sd=Sf>Sb=Se holds true, where Sa is the area of the cross section A-A, Sb is the area of the cross section B-B, Sc is the area of the cross section C-C, Sd is the area of the cross section D-D, Se is the area of the cross section E-E, and Sf is the arear of the cross section F-F. This magnitude relationship can be regarded as a magnitude relationship between shear rigidities of the cross sections. Thus, within the first vibration damping region A1, the first connection portion 98 is more likely to undergo shear deformation in X and Y directions than the first mount portion 92 and the second mount portion 94, and within the second vibration damping region A2, the second connection portion 100 is more likely to undergo shear deformation in X and Y directions than the second mount portion 94 and the third mount portion 96.

When the pair of shear blades 16 shown in FIG. 6 is driven, the working unit 4 vibrates in the front-rear direction (in X direction of the vibration damping members 90a, 90b, in Y direction of the vibration damping member 90c) due to the reciprocation of the shear blades 16. In this case, the vibrations of the working unit 4 are transmitted, via the second mount elements 134, 152, 168, the first vibration damping regions A1 of the vibration damping members 90a, 90b, 90c (see FIG. 8), and the first mount elements 128, 146, 164 in this order, to the base 6. The vibrations of the working unit 4 are also transmitted, via the second mount elements 134, 152, 168, the second vibration damping regions A2 of the vibration damping members 90a, 90b, 90c (see FIG. 8), and the third mount elements 140, 158, 174 in this order, to the base 6. In the course of the vibration transmission, the first connection portions 98 within the first vibration damping regions A1 of the vibration damping members 90a, 90b 90c undergo large shear deformation in the front-rear direction and the second connection portions 100 within the second vibration damping regions A2 of the vibration damping members 90a, 90b, 90c also undergo large shear deformation in the front-rear direction, which reduces the vibrations to the base 6. Since the vibration damping member 90c and the first mount element 164 are not restricted with a recess and a projection, a force (i.e., vibrations) is transmitted therebetween only by the mount surface 106 and the support surface 166 rubbing against each other. Thus, it can be construed that vibration isolation is provided between the vibration damping member 90c and the first mount element 164.

### Cooling Configuration of Hedge Trimmer 2

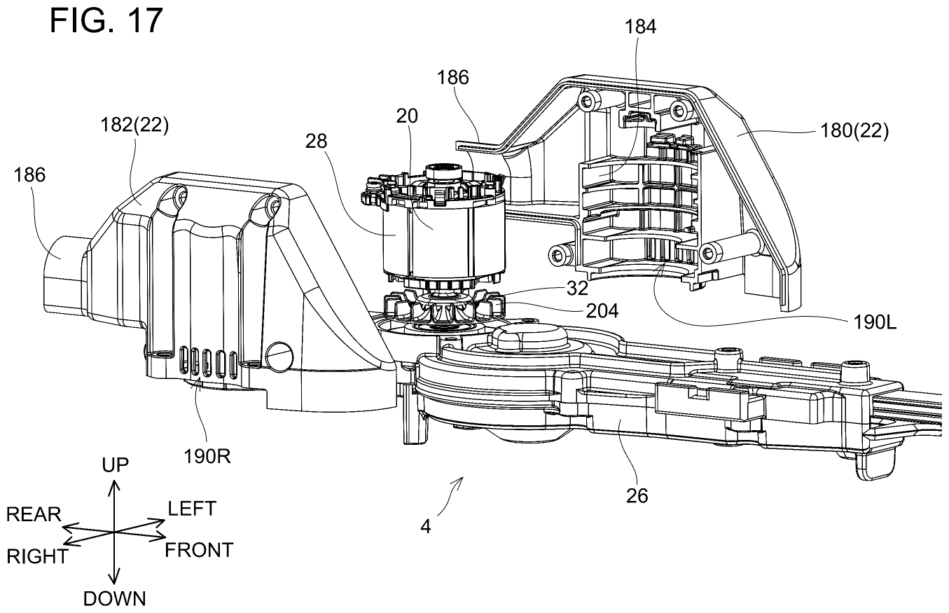

As shown in FIG. 17, the motor housing 22 is constituted of a left housing member 180 and a right housing member 182. The left housing member 180 and the right housing member 182 are fixed to each other with screws (not shown). A motor supporting frame 184 is formed on the inner wall of the motor housing 22. The motor supporting frame 184 is in contact with the outer surface of the stator 28 to support the electric motor 20. The motor supporting frame 184 is divided to a portion formed on the left housing member 180 and a portion formed on the right housing member 182 (not shown). When the motor housing 22 is removed, the outer surface of the stator 28 is exposed to the outside of the hedge trimmer 2.

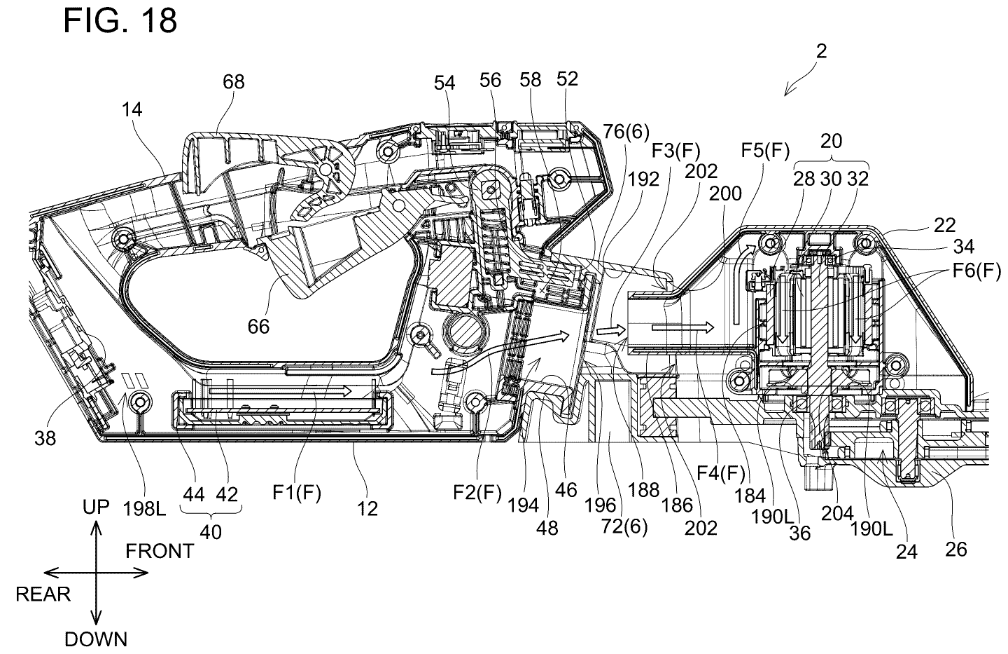

As shown in FIG. 18, the motor housing 22 comprises a duct 186 extending rearward from a position located rearward of the electric motor 20, an air inlet 188 defined at the rear end of the duct 186, an air outlet 190L defined in the left surface of the motor housing 22, and an air outlet 190R (see FIG. 17) defined in the right surface of the motor housing 22. The air inlet 188 is open to the inside of a passage 192 defined in the base 6. The air outlets 190R, 190L are both open to the outside of the hedge trimmer 2.

The rear housing 12 comprises a through hole 194 that extends through the shaft portion 46 to communicate the inside of the rear housing 12 with the outside thereof, an air outlet 196 which is the front opening of the through hole 194, an air inlet 198L defined in the left surface of the rear housing 12, and an air inlet 198R (see FIG. 1) defined in the right surface of the rear housing 12. The air outlet 196 is open to the inside of the passage 192 defined in the base 6. The air inlets 198L, 198R are both open to the outside of the hedge trimmer 2.

The passage 192 is located forward of the shaft holding portion 48. The passage 192 and the shaft holding portion 48 are partially in the base body 72 and partially in the semicylindrical member 76. An opening 200 is defined at the front end of the passage 192 and the duct 186 of the motor housing 22 is inserted to the opening 200. There is a clearance 202 between the outer surface of the duct 186 and the periphery of the opening 200. Without the clearance 202, the motor housing 22 would contact the semicylindrical member 76, which results in direct vibration transmission from the working unit 4 to the base 6. The clearance 202 prevents the motor housing 22 from contacting the semicylindrical member 76, thereby preventing direct vibration transmission from the working unit 4 to the base 6. The clearance 202 is closed by a dust blocking member (not shown). A material that barely transmits vibrations (e.g., sponge) is used for the dust blocking member. This prevents foreign particles such as dust from entering the hedge trimmer 2 through the clearance 202.

The hedge trimmer 2 comprises a cooling air passage F extending from the air inlets 198L, 198R in the rear housing 12 to the air outlets 190R, 190L in the motor housing 22 via the inside of the rear housing 12, the air outlet 196 in the rear housing 12, the inside of the passage 192, the air inlet 188 in the motor housing 22, and the inside of the motor housing 22. In this embodiment, a fan 204 is fixed to the output shaft 32 and the fan 204 generates an air flow (which may be simply termed cooling air) along the cooling air passage F. The fan 204 is located below the rotor 30 and overlaps the air outlets 190R, 190L when viewed in the right-left direction. When the electric motor 20 operates, the fan 204 rotates with the output shaft 32, thereby generating the cooling air in the cooling air passage F.

The cooling air passage F comprises a first passage section F1 in which air flows from the air inlets 198L, 198R to a lower front portion of the rear housing 12, a second passage section F2 in which the air flows from the lower front portion of the rear housing 12 via the through hole 194 to the air outlet 196, a third passage section F3 in which the air flows from the air outlet 196 via the inside of the passage 192 to the air inlet 188, a fourth passage section F4 in which the air flows from the air inlet 188 forward via the inside of the duct 186, a fifth passage section F5 in which the air flows along the rear surface of the motor supporting frame 184 to an upper portion of the motor housing 22, and a sixth passage section F6 in which the air flows from the upper portion of the motor housing 22 via spacing between the stator 28 and the rotor 30 of the electric motor 20 to the air outlets 190R, 190L.

The control unit 40 is located in the first passage section F1. The first passage section F1 extends along the longitudinal direction of the control unit 40 (i.e., the front-rear direction). The air inlets 198L, 198R of the rear housing 12 are located rearward of the rear end of the control unit 40. Thus, the control unit 40 can be cooled from the rear end over to the front end by the cooling air flowing in the first passage section F1.

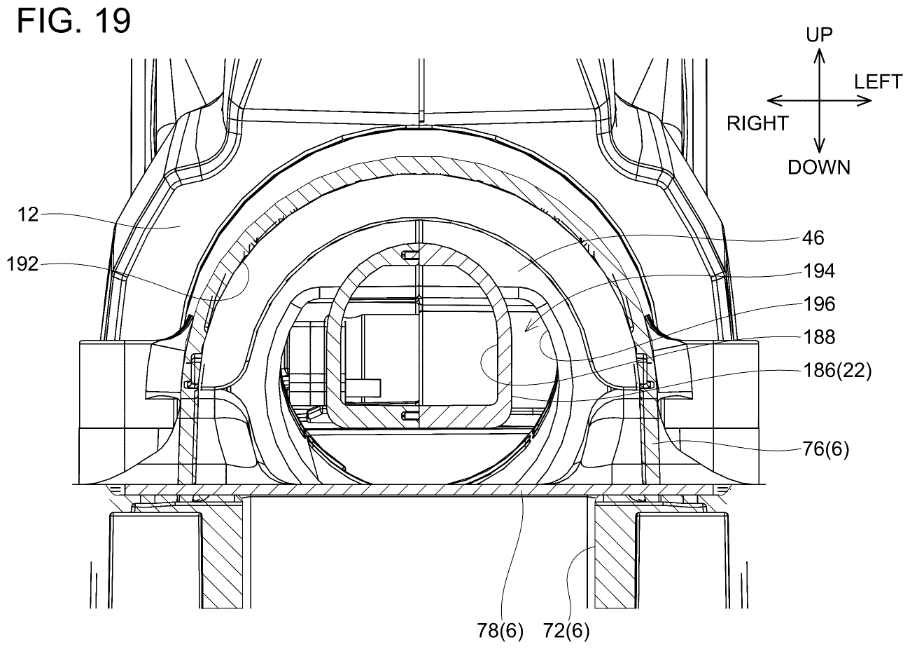

As shown in FIG. 19, as the inside of the passage 192 is viewed in the front-rear direction, the air inlet 188 of the motor housing 22 and the air outlet 196 of the rear housing 12 overlap each other. This allows the cooling air to smoothly flows in the third passage section F3.

Electric wires electrically connecting electric components housed in the rear housing 12 to electric components housed in the motor housing 22 are located in the cooling air passage F, although this is not shown. For example, an electric wire electrically connecting the control unit 40 housed in the rear housing 12 to the electric motor 20 housed in the motor housing 22 is located in the cooling air passage F.

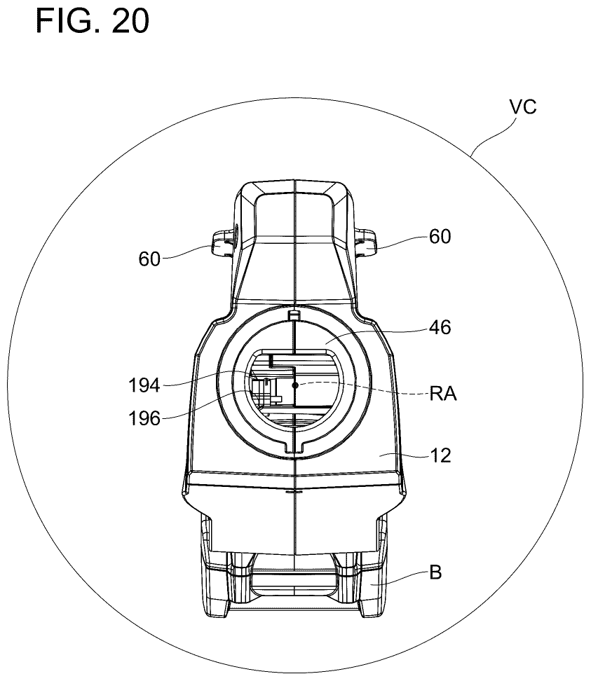

FIG. 20 shows the rear housing 12, the battery pack B attached to the battery receptacle 38 of the rear housing 12, and an imaginary circle VC with the rotation axis RA defining the center of the circle. The radius of the imaginary circle VC is for example in the range from 5 cm to 15 cm, and it is 13 cm in this embodiment. As viewed in the direction of the rotation axis RA, the rear housing 12 and the battery pack B are located within the imaginary circle VC.

As shown in FIG. 2, a center of gravity BG of the battery pack B attached to the battery receptacle 38 is located rearward of a rear end 14r of the rear handle 14. A center of gravity HG of the hedge trimmer 2 is located rearward of a rear end 8r of the front handle 8 and forward of a front end 14f of the rear handle 14. Further, the center of gravity HG of the hedge trimmer 2 is located within the motor housing 22. It should be noted that the center of gravity HG herein means the center of gravity of the hedge trimmer 2 in which the battery pack B is attached to the battery receptacle 38 and the rear housing 12 is in the normal position. Even when the rear housing 12 is in the rotated position, the center of gravity of the hedge trimmer 2 in which the battery pack B is attached to the battery receptacle 38 is located rearward of the rear end 8r of the front handle 8 and forward of the front end 14f of the rear handle 14, although this is not shown.

### Variants

The working machine may be a working machine other than the hedge trimmer 2 (e.g., a reciprocating saw, a chainsaw, a grass trimmer). In this case, the working unit 4 may comprise, instead of the pair of shear blades 16, another working mechanism (e.g., a saw, a saw chain, a rotary blade).

The hedge trimmer 2 may reciprocate only one of the shear blades 16 instead of reciprocating both of the shear blades 16.

The prime mover configured to drive the pair of shear blades 16 may be a prime mover other than the electric motor 20 (e.g., an engine with a combustion mechanism).

Instead of the battery receptacle 38, a power cable for connection to an external power supply (e.g., a commercial power supply or a backpack-type power supply) may be located on the rear housing 12. In this case, the hedge trimmer 2 may operate with electric power supplied through the power cable from the external power supply.

The electric motor 20 may be a motor other than the inner rotor brushless motor (e.g., an outer rotor brushless motor, a brush motor, or the like).

The base 6 may house the motor housing 22 and the mechanism housing 26. In this case, the motor housing 22 and the mechanism housing 26 may be invisible when the hedge trimmer 2 is viewed from the outside.

(See FIG. 6.) The base 6 may not comprise the left support 80 nor the left arm 86. In this case, the base 6 may support the working unit 4 by the right support 82 via the vibration damping member 90b and by the rear support 84 via the vibration damping member 90c. Alternatively, the base 6 may not comprise the right support 82 nor the right arm 88. In this case, the base 6 may support the working unit 4 by the left support 80 via the vibration damping member 90a and by the rear support 84 via the vibration damping member 90c.

(See FIG. 18.) The control unit 40 may not be located in the first passage section F1. For example, the control unit 40 may be located in the second passage section F2. In this case, the longitudinal direction of the control unit 40 may be along the up-down direction. Alternatively, the control unit 40 may not be located in the cooling air passage F. For example, the control unit 40 may be located forward of the battery receptacle 38 to face the battery receptacle 38.

(See FIG. 3.) The rear housing 12 may be attached to the base 6 such that it cannot rotate. In this case, the hedge trimmer 2 may not comprise elements such as the rotation locking member 54, the plurality of engagement grooves 52, the receiving groove 58, etc.

(See FIG. 17.) A member that covers the electric motor 20 (e.g., a cylindrical cover extending along the outer surface of the stator 28) may be provided between the motor housing 22 and the electric motor 20. In this case, the outer surface of the stator 28 may not be exposed to the outside of the hedge trimmer 2 even whether motor housing 22 is removed.

(See FIG. 2.) The shape of the rear portion of the rear housing 12 and the position and shape of the battery receptacle 38 may be varied. In this case, the slide direction SD of the battery pack B may be different from the direction described in connection with the embodiment. For example, the slide direction SD may be an upward direction, a rightward direction, or a forward direction.

(See FIG. 20.) When viewed in the direction of the rotation axis RA, at least a part of the rear housing 12 and/or at least a part of the battery pack B may be located outside the imaginary circle VC.

(See FIG. 2.) The center of gravity BG of the battery pack B attached to the battery receptacle 38 may be located forward of the rear end 14r of the rear handle 14.

(See FIG. 2.) The center of gravity HG of the hedge trimmer 2 may be located forward of the rear end 8r of the front handle 8. Alternatively, the center of gravity HG of the hedge trimmer 2 may be located rearward of the front end 14f of the rear handle 14.

(See FIG. 6.) Since the vibration damping members 90a, 90b, 90c each are symmetric in Z direction, the first mount portions 92 may be mounted to the third mount elements 140, 158, 174 and the third mount portions 96 may be mounted to the first mount elements 128, 146, 164. In this case, the second mount portions 94 may be mounted to the second mount elements 134, 152, 168 by fitting the plurality of projections 138, 156, 172 into the plurality of mount holes 114.

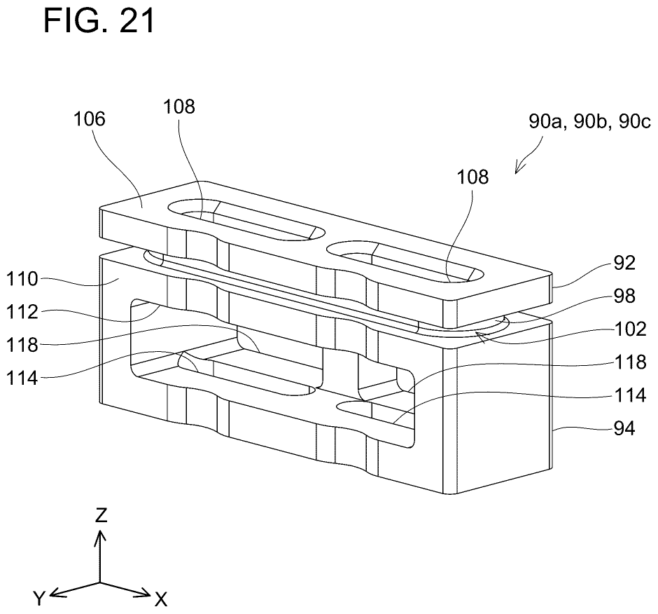

As shown in FIG. 21, each of the vibration damping members 90a, 90b, 90c may not comprise the third mount portion 96 nor the second connection portion 100. Even without them, the base 6 can hold the working unit 4 by mounting the first mount portions 92 to the third mount elements 140, 158, 174 and mounting the second mount portions 94 to the second mount elements 134, 152, 168. In this case, when the working unit 4 vibrates, the first connection portions 98 undergo relatively large shear deformation, which reduces vibrations from the second mount portions 94 to the first mount portions 92 via the first connection portions 98. Thus, vibrations from the working unit 4 to the front handle 8 on the base 6 can be reduced.

(See FIG. 7.) The shape of the vibration damping members 90a, 90b, 90c is not limited to the cuboid shape. The vibration damping members 90a, 90b, 90c may have for example a substantially cylindrical shape whose height direction is different from Z direction.

(See FIG. 10.) The hollow space 120 may not be defined in each first connection portion 98. That is, each first connection portion 98 may be solid. The hollow space 126 may not be defined in each second connection portion 100. That is, each second connection portion 100 may be solid.

(See FIG. 7.) Each second mount portion 94 may not comprise the plurality of lightening holes 118.

(See FIG. 7.) The shape of the first mount portions 92 (the third mount portions 96) may be varied. For example, each of the first mount portions 92 (the third mount portions 96) may comprise a projection projecting from the mount surface 106 (the mount surface 122) in +Z direction (in −Z direction), instead of the plurality of mount holes 108 (the plurality of mount holes 124). The shape of the first mount elements 128, 146, 164 (the third mount elements 140, 158, 174) may also be varied corresponding to the shape of the first mount portions 92 (the third mount portions 96). For example, if each first mount portion 92 (each third mount portion 96) comprises the projection, each of the first mount elements 128, 146, 164 (the third mount elements 140, 158, 174) may comprise a hole or recess configured to receive the projection.

(See FIG. 7.) The shape of the second mount portions 94 may be varied. For example, each second mount portion 94 may not comprise the plurality of mount holes 114 or the plurality of mount holes 116. The second mount elements 134, 152, 168 may not comprise the plurality of mount projections 138, 156, 172.

(See FIG. 10.) The plurality of mount holes 108 and the hollow spaces 120, the hollow spaces 120 and the plurality of mount holes 116, the plurality of mount holes 124 and the hollow spaces 126, or the hollow spaces 126 and the plurality of mount holes 114 may not be spatially connected.

### Features of Embodiment

As described, in one or more embodiments, the hedge trimmer 2 (an example of working machine) comprises the working unit 4 (an example of first working machine part) including the pair of shear blades 16 (an example of working mechanism) configured to be driven by the electric motor 20 (an example of prime mover), the base 6 (an example of second working machine part) including the front handle 8 (an example of handle) configured to be grasped by the user, and the vibration damping members positioned between the working unit 4 and the base 6. The base 6 (an example of one of the first working machine part and the second working machine part) comprises the first mount elements 128, 146, 164. The working unit 4 (an example of the other of the first working machine part and the second working machine part) comprises the second mount elements 134, 152, 168. The vibration damping members 90a, 90b, 90c each comprise the first mount portion 92 configured to be attached to the corresponding one of the first mount elements 128, 146, 164, the second mount portion 94 offset in −Z direction (an example of first direction) from the first mount portion 92 and configured to be attached to the corresponding one of the second mount elements 134, 152, 168, the first connection portion 98 connecting the first mount portion 92 to the second mount portion 94, and the first recessed groove 102 defined in a portion of the outer surface of the corresponding one of the vibration damping members 90a, 90b, 90c that corresponds to the outer surface of the first connection portion 98, wherein the first recessed groove 102 is recessed in a direction orthogonal to −Z direction.

In the configuration above, the cross-sectional area of each first connection portion 98 along the direction orthogonal to −Z direction is decreased by the first recessed groove 102. This means that the shear rigidity of the first connection portion 98 is decreased in the direction orthogonal to −Z direction, and thus the first connection portion 98 is more likely to undergo shear deformation in the direction orthogonal to −Z direction. By arranging the vibration damping members 90a, 90b, 90c such that the direction in which the working unit 4 vibrates (that is, the front-rear direction) is orthogonal to −Z direction, the first connection portions 98 undergo large shear deformation when the working unit 4 vibrates, thereby significantly reducing vibrations from the working unit 4 to the base 6. Thus, the configuration above allows for a reduction in vibrations to be transmitted to the front handle 8, and thus reduces user's uncomfortableness.

In one or more embodiments, the hollow space 120 is defined inside each first connection portion 98.

In the configuration above, the cross-sectional area of each first connection portion 98 along the direction orthogonal to −Z direction is further decreased by the hollow space 120. Thus, the shear rigidity of the first connection portion 98 in the direction orthogonal to −Z direction is further decreased, and the first connection portion 98 is more likely to undergo shear deformation in the direction orthogonal to −Z direction. Therefore, when the working unit 4 vibrates in the direction orthogonal to −Z direction, vibrations from the working unit 4 to the base 6 are further reduced.

In one or more embodiments, the first mount elements 128, 146 respectively comprise the plurality of mount projections 132, 150 (an example of first mount projection) projecting in −Z direction. Each first mount portion 92 comprises the plurality of mount holes 108 (an example of first mount hole) defined in the outer surface of its corresponding vibration damping member 90a, 90b, 90c and recessed in −Z direction, wherein the mount holes 108 are configured to receive the mount projections 132, 150.

According to the configuration above, the first mount elements 128, 146 are restrained by the first mount portions 92 in the direction orthogonal to −Z direction by the mount projections 132, 150 being received by the mount holes 108. This facilitates positioning of the first mount portions 92 to the first mount elements 128, 146.

In one or more embodiments, the hollow space 120 is defined inside each first connection portion 98. The mount holes 108 are connected to the hollow space 120.

The configuration above allows the mount holes 108 and the hollow spaces 120 to be formed using the same mold in manufacturing the vibration damping members 90a, 90b, 90c by mold injection. The configuration above thus facilitates the manufacture of the vibration damping members 90a, 90b, 90c.

In one or more embodiments, the second mount elements 134, 152, 168 each comprise the mount frame 136, 154, 170 projecting in −Y direction (an example of second direction) orthogonal to −Z direction. Each second mount portion 94 comprises the mount recess 112 defined in the outer surface of the vibration damping member 90a, 90b, 90c and recessed in-Y direction, wherein the mount recesses 112 are configured to receive the mount frames 136, 154, 170.

According to the configuration above, the second mount elements 134, 152, 168 are restrained by the second mount portions 94 in a direction orthogonal to −Y direction by the mount frames 136, 154, 170 being received by the mount recesses 112. This facilitates positioning of the second mount portions 94 to the second mount elements 134, 152, 168.

In one or more embodiments, the second mount elements 134, 152, 168 further comprise the plurality of mount projections 138, 156, 172 (an example of second mount projection) projecting from the outer surfaces of the mount frames 136, 154, 170 in +Z direction (an example of third direction) opposite to −Z direction. Each second mount portion 94 further comprises the plurality of mount holes 116 (an example of second mount hole) defined in the wall surface of the mount recesses 112 and recessed in +Z direction, wherein the mount holes 116 are configured to receive the corresponding mount projections 138, 156, 172.

In the configuration above, when the mount frame 136, 154, 170 is about to detach from the mount recess 112, the mount projections 138, 156, 172 are caught by the mount holes 116, thereby preventing the mount frame 136, 156, 172 from detaching from the mount recess 112. The configuration above thus prevents the vibration damping members 90a, 90b, 90c from being detached from the second mount elements 134, 152, 168.

In one or more embodiments, the hollow space 120 is defined inside each first connection portion 98. The mount holes 116 are connected to the hollow space 120.

The configuration above allows the mount holes 116 and the hollow spaces 120 to be formed using the same mold in manufacturing the vibration damping members 90a, 90b, 90c by mold injection. The configuration above thus facilitates the manufacture of the vibration damping members 90a, 90b, 90c.

In one or more embodiments, the base 6 further comprises the third mount elements 140, 158, 174 different from the first mount elements 128, 146, 164. The vibration damping members 90a, 90b, 90c each further comprise the third mount portion 96 offset in −Z direction from the second mount portion 94 and configured to be attached to the third mount element 140, 158, 174, the second connection portion 100 connecting the second mount portion 94 to the third mount portion 96, and the second recessed groove 104 defined in a portion of its corresponding outer surface of the vibration damping member 90a, 90b, 90c that corresponds to the outer surface of the second connection portion 100, wherein the second recessed groove 104 is recessed in the direction orthogonal to −Z direction.

According to the configuration above, the base 6 further comprises the additional mount elements (that is, the third mount elements 140, 158, 174) and the vibration damping members 90a, 90b, 90c are attached to the third mount elements 140, 158, 174 via the additional mount portions (that is, the third mount portions 96). This allows the vibration damping members 90a, 90b, 90c to be attached relatively firmly to the base 6. In the configuration, however, vibrations from the working unit 4 are transmitted to the base 6 not only via the first mount elements 128, 146, 164, the first mount portions 92, the first connection portions 98, the second mount portions 94, and the second mount elements 134, 152, 168, but also via the third mount elements 140, 158, 174, the third mount portions 96, the second connection portions 100, the second mount portions 94, and the second mount elements 134, 152, 168. Therefore, if the second connection portions 100 are configured such that they do not easily undergo shear deformation, vibrations from the working unit 4 may be transmitted to the base 6 without being sufficiently reduced. Regarding this, in the above configuration, the cross-sectional areas of the second connection portions 100 along the direction orthogonal to −Z direction are decreased by the second recessed grooves 104. This means that the shear rigidity of the second connection portions 100 is decreased in the direction orthogonal to −Z direction, and thus the second connection portions 100 are more likely to undergo shear deformation in the direction orthogonal to −Z direction. By arranging the vibration damping members 90a, 90b, 90c such that the direction in which the working unit 4 vibrates is orthogonal to −Z direction, the second connection portions 100 undergo large shear deformation when the working unit 4 vibrates, thereby significantly reducing vibrations from the working unit 4 to the base 6.

In one or more embodiments, the working mechanism comprises the pair of shear blades 16 (an example of pair of blades) configured to reciprocate relative to each other by being driven by the electric motor 20. The vibration damping members 90a, 90b, 90c are arranged such that −Z direction is orthogonal to the direction in which the pair of shear blades 16 reciprocates (that is, the front-rear direction).

The above-described vibration damping members 90a, 90b, 90c produce a remarkable vibration-damping effect against vibrations of the working unit 4 in the direction orthogonal to −Z direction. Thus, if the direction in which the pair of shear blades 16 reciprocates (that is, the front-rear direction) is not orthogonal to −Z direction, vibrations caused by the reciprocation of the pair of shear blades 16 may not be sufficiently reduced and may be transmitted to the front handle 8, which may make the user feel uncomfortable. In the configuration above, the direction in which the pair of shear blades 16 reciprocates (that is, the front-rear direction) is orthogonal to −Z direction, and thus vibrations caused by the reciprocation of the pair of shear blades 16 are sufficiently reduced by the vibration damping members 90a, 90b, 90c before transmitted to the front handle 8. Therefore, the configuration above can reduce the uncomfortableness of the user grasping the front handle 8.

What is claimed is:

1. A working machine comprising:
a first working machine part including a working mechanism configured to be driven by a prime mover;
a second working machine part including a handle configured to be grasped by a user; and
a vibration damping member positioned between the first working machine part and the second working machine part,
wherein one of the first working machine part and the second working machine part comprises a first mount element,
the other of the first working machine part and the second working machine part comprises a second mount element, and
the vibration damping member comprises:
a first mount portion configured to be attached to the first mount element;
a second mount portion offset in a first direction from the first mount portion and configured to be attached to the second mount element;
a first connection portion connecting the first mount portion to the second mount portion; and
a first recessed groove defined in a portion of an outer surface of the vibration damping member that corresponds to an outer surface of the first connection portion, wherein the first recessed groove is recessed in a direction orthogonal to the first direction.

2. The working machine according to claim 1, wherein
a hollow space is defined inside the first connection portion.

3. The working machine according to claim 1, wherein
the first mount element comprises a first mount projection projecting in the first direction, and
the first mount portion comprises a first mount hole defined in the outer surface of the vibration damping member and recessed in the first direction, wherein the first mount hole is configured to receive the first mount projection.

4. The working machine according to claim 3, wherein
a hollow space is defined inside the first connection portion, and
the first mount hole is connected to the hollow space.

5. The working machine according to claim 1, wherein
the second mount element comprises a mount frame projecting in a second direction orthogonal to the first direction, and
the second mount portion comprises a mount recess defined in the outer surface of the vibration damping member and recessed in the second direction, wherein the mount recess is configured to receive the mount frame.

6. The working machine according to claim 5, wherein
the second mount element further comprises a second mount projection projecting from an outer surface of the mount frame in a third direction opposite to the first direction, and
the second mount portion further comprises a second mount hole defined in a wall surface of the mount recess and recessed in the third direction, wherein the second mount hole is configured to receive the second mount projection.

7. The working machine according to claim 6, wherein
a hollow space is defined inside the first connection portion, and
the second mount hole is connected to the hollow space.

8. The working machine according to claim 1, wherein
the one of the first working machine part and the second working machine part further comprises a third mount element different from the first mount element, and
the vibration damping member further comprises:
a third mount portion offset in the first direction from the second mount portion and configured to be attached to the third mount element;
a second connection portion connecting the second mount portion to the third mount portion; and
a second recessed groove defined in a portion of the outer surface of the vibration damping member that corresponds to an outer surface of the second connection portion, wherein the second recessed groove is recessed in the direction orthogonal to the first direction.

9. The working machine according to claim 1, wherein
the working mechanism comprises a pair of blades configured to reciprocate relative to each other by being driven by the prime mover, and
the vibration damping member is arranged such that the first direction is orthogonal to a direction in which the pair of blades reciprocates.

10. The working machine according to claim 2, wherein
the first mount element comprises a first mount projection projecting in the first direction,
the first mount portion comprises a first mount hole defined in the outer surface of the vibration damping member and recessed in the first direction, wherein the first mount hole is configured to receive the first mount projection,
the first mount hole is connected to the hollow space,
the second mount element comprises a mount frame projecting in a second direction orthogonal to the first direction,
the second mount portion comprises a mount recess defined in the outer surface of the vibration damping member and recessed in the second direction, wherein the mount recess is configured to receive the mount frame,
the second mount element further comprises a second mount projection projecting from an outer surface of the mount frame in a third direction opposite to the first direction,
the second mount portion further comprises a second mount hole defined in a wall surface of the mount recess and recessed in the third direction, wherein the second mount hole is configured to receive the second mount projection,
the second mount hole is connected to the hollow space,
the one of the first working machine part and the second working machine part further comprises a third mount element different from the first mount element,
the vibration damping member further comprises:
a third mount portion offset in the first direction from the second mount portion and configured to be attached to the third mount element;
a second connection portion connecting the second mount portion to the third mount portion; and
a second recessed groove defined in a portion of the outer surface of the vibration damping member that corresponds to an outer surface of the second connection portion, wherein the second recessed groove is recessed in the direction orthogonal to the first direction,
the working mechanism comprises a pair of blades configured to reciprocate relative to each other by being driven by the prime mover, and
the vibration damping member is arranged such that the first direction is orthogonal to a direction in which the pair of blades reciprocates.

11. A vibration damping member positioned between a first working machine part and a second working machine part of a working machine, wherein
the first working machine part includes a working mechanism configured to be driven by a prime mover,
the second working machine part includes a handle configured to be grasped by a user,
one of the first working machine part and the second working machine part comprises a first mount element,
the other of the first working machine part and the second working machine part comprises a second mount element, and
the vibration damping member comprises:
a first mount portion configured to be attached to the first mount element;
a second mount portion offset in a first direction from the first mount portion and configured to be attached to the second mount element;
a first connection portion connecting the first mount portion to the second mount portion; and
a first recessed groove defined in a portion of an outer surface of the vibration damping member that corresponds to an outer surface of the first connection portion, wherein the first recessed groove is recessed in a direction orthogonal to the first direction.

12. The vibration damping member according to claim 11, wherein
a hollow space is defined inside the first connection portion,
the first mount element comprises a first mount projection projecting in the first direction,
the first mount portion comprises a first mount hole defined in the outer surface of the vibration damping member and recessed in the first direction, wherein the first mount hole is configured to receive the first mount projection,
the first mount hole is connected to the hollow space,
the second mount element comprises a mount frame projecting in a second direction orthogonal to the first direction,
the second mount portion comprises a mount recess defined in the outer surface of the vibration damping member and recessed in the second direction, wherein the mount recess is configured to receive the mount frame,
the second mount element further comprises a second mount projection projecting from an outer surface of the mount frame in a third direction opposite to the first direction,
the second mount portion further comprises a second mount hole defined in a wall surface of the mount recess and recessed in the third direction, wherein the second mount hole is configured to receive the second mount projection,
the second mount hole is connected to the hollow space,
the one of the first working machine part and the second working machine part further comprises a third mount element different from the first mount element,
the vibration damping member further comprises:
a third mount portion offset in the first direction from the second mount portion and configured to be attached to the third mount element;
a second connection portion connecting the second mount portion to the third mount portion; and
a second recessed groove defined in a portion of the outer surface of the vibration damping member that corresponds to an outer surface of the second connection portion, wherein the second recessed groove is recessed in the direction orthogonal to the first direction,
the working mechanism comprises a pair of blades configured to reciprocate relative to each other by being driven by the prime mover, and
the vibration damping member is arranged such that the first direction is orthogonal to a direction in which the pair of blades reciprocates.
